(19) United States
(12) Patent Application Publication
(10) Pub. No.: US 2010/0330853 A1
(43) Pub. Date: Dec. 30, 2010

(54) METHOD FOR CONTROLLING A DRIVE SYSTEM IN A MOTOR BOAT

(76) Inventors: Sandeep Bisht, Heilbronn (DE); Joerg Haffelder, Bad Rappenau (DE); Daniel Roesinger, Lauffen Am Neckar (DE); Rene Neusinger, Ludwigsburg (DE); Daniel Damm, Ludwigsburg (DE)

Correspondence Address: KENYON & KENYON LLP, ONE BROADWAY, NEW YORK, NY, 10004, US

(21) Appl. No.: 12/818,471

(22) Filed: Jun. 18, 2010

(30) Foreign Application Priority Data
Jun. 30, 2009 (DE) 10 2009 027 322.0

(51) Int. Cl. B63H 21/21; G05D 1/00

(52) U.S. Cl. 440/1; 440/84; 440/87; 440/38; 701/21

(57) ABSTRACT

In recreational boats, multiple drive units, e.g., multiple outboard motors, Z-drives, or jet drives, are often provided to propel the boat, at least one of the drive units having a propulsion reversal function for executing a reverse propulsion. To facilitate execution of a turning maneuver with a boat in an extremely tight space, and to ensure that even an unskilled person is able to reliably execute such a turning maneuver, it is provided that the drive units be activated automatically for executing the turn on the spot as a function of a command for turning. The command may be made via a switch, which is operated by the driver of the boat. One drive unit is then operated automatically in propulsion reversal mode, and the other drive unit is operated in propulsion mode. The power of the drive units is then controlled in such a way that the instantaneous efficiency of the drive units operated during turning is taken into account. The drive units are activated by at least one control unit in such a way that the boat is turned automatically. The driver of the boat here may preferably specify the direction of the turn.

### FIELD OF THE INVENTION

The present invention relates to a method for controlling a motor drive system in a boat, where the drive system includes at least two controllable drive units, at least one of the drive units having a propulsion reversal function for executing a reverse propulsion.

The present invention also relates to a device for controlling a motor drive system in a boat, the drive system including at least two controllable drive units, at least one of the drive units having a propulsion reversal function for executing a reverse propulsion, and the device having at least one control unit for controlling and/or regulating the operation of at least one drive unit.

The present invention also relates to a computer program capable of running on a control unit for controlling a drive system in a motor boat.

### BACKGROUND INFORMATION

Motor boats often have multiple drive units, for example multiple outboard motors for driving the boat. It is common in particular for two drive units to be installed, the driver's intent being specifiable via a separate throttle for each drive unit. To propel the boat in reverse, the drive units have a propulsion reversal function. On outboard motors, for example, the entire motor drive unit may be rotated by 180° or propulsion reversal is possible by activating a gear. In so-called Z-drives, the propulsion reversal is accomplished by activating a gear. The propulsion reversal function may often be controlled electrically.

Recreational boats are increasingly being propelled by a so-called water jet drive or jet drive. These have a propulsion reversal valve, which allows reverse propulsion.

In harbor areas or in narrow navigation channels in particular, it may happen that the motor boat must be turned in the tightest space. Rotation about the approximate midpoint of the boat is referred to as a turn on the spot and requires a minimum amount of space. To execute such a turn on the spot, i.e., turning almost on the spot, the two throttles are controlled or adjusted by the driver to turn the boat. However, implementing such a turn in the tightest space requires a high level of experience. Furthermore, various boats and their drive systems differ greatly with regard to handling and the effect of the drive system, which is manifested in extreme maneuvers such as turning on the spot in particular.

### SUMMARY OF THE INVENTION

An object of the present invention is to create a possibility for facilitating the implementation of a turning maneuver in an extremely tight space with a boat of the type defined in the introduction and to ensure that even unskilled operators will be able to safely execute such a turning maneuver.

According to the present invention, the drive units are automatically controlled for executing a turn on the spot. This is done as a function of a turn request by the driver. This request may be issued via a switch, which is operated by the driver of the boat, for example. If the drive system of the motor boat includes two drive units, then one drive unit is automatically operated in propulsion reversal mode and the other drive unit is operated in propulsion mode. The power of the two drive units is controlled in such a way that the prevailing efficiency of the drive units operated during turning is taken into account. The drive units are thus controlled by the motor controller in such a way that the boat is turned automatically.

The driver of the boat may preferably specify the direction of the turn here. This may be done by a switch, for example. However, the direction is preferably indicated by operation of the steering wheel. Taking into account the different efficiencies of the drive units in moving forward and in reverse ensures that the boat will not move forward or in reverse during turning. This therefore allows turning to be accomplished in the tightest space.

The drive system may be controlled via a central control unit for control of both drive units. The power of the drive units is also controlled via the central control unit. In drive systems, one control unit may often be provided for each drive unit. To implement the method according to the present invention, such control units may be linked together by a signal line, e.g., a bus system, in such a way that data exchange among the control units is made possible. The motor control units then adjust corresponding torques as a function of the desired direction of turning to generate suitable thrust vectors in the boat. At least one of the drive units is set for reverse propulsion. The choice of drive unit set for reverse propulsion is made as a function of the desired direction of turning. If the boat is to be turned to the left, the left drive unit is operated in propulsion reversal mode; if the boat is to be turned to the right (clockwise), then the drive unit on the right is operated in propulsion reversal mode.

With drive units, in particular when they are designed as jet drives, there may often be a substantial difference in efficiency between propulsion mode and propulsion reversal mode. To enable turning on the spot, however, it is necessary for the forward propulsion and the reverse propulsion to be compensated. Therefore, according to the present invention, the difference in efficiencies is automatically taken into account by specifying different torque requirements or rotational speed requirements. For this purpose, thrust information for forward propulsion and reverse propulsion stored in engine characteristics maps, for example, may be used. The method according to the present invention may be used in all drive systems having automatic torque selection or rotational speed selection. This may be a vehicle speed regulator (FGR), for example. However, a so-called EGAS system is preferably used to be able to execute increases in torque even without input by the driver.

Implementation of the present invention in the form of a computer program capable of running on a computer, in particular on one control unit or on multiple control units for controlling and/or regulating the operation of the drive units in a boat, is important in particular, the computer program being programmed to implement the method according to the present invention. The computer program is preferably stored on an electronic or optical storage medium.

### BRIEF DESCRIPTION OF THE DRAWINGS

FIG. 1 shows a schematic diagram of a specific embodiment of a drive system in a motor boat according to the present invention.

FIG. 2 shows a simplified flow chart of one possible specific embodiment of the method according to the present invention.

FIG. 3 shows a schematic diagram of another exemplary embodiment of a drive system in a motor boat according to the present invention.

### DETAILED DESCRIPTION

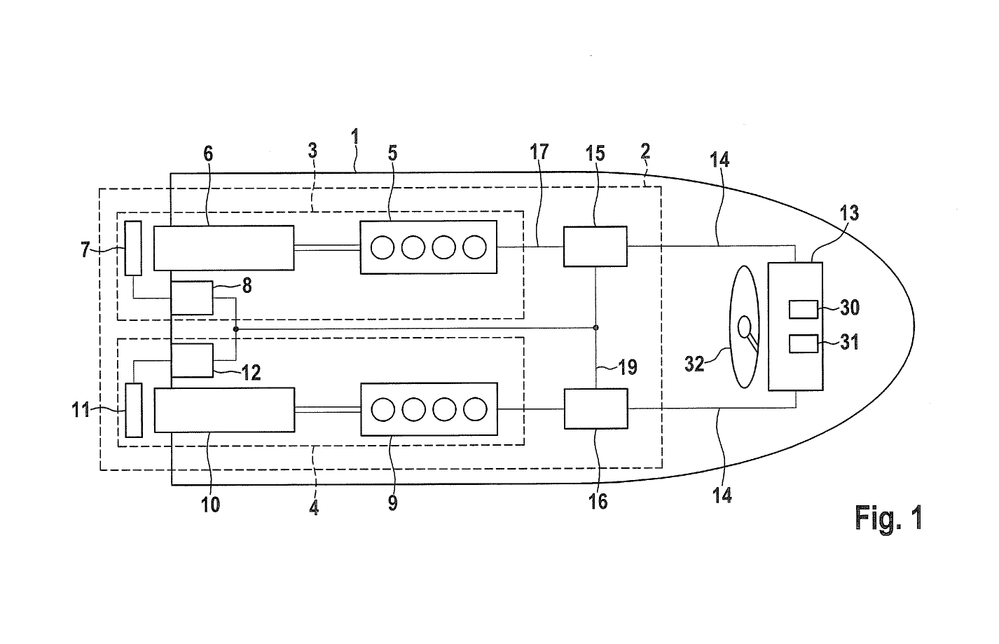

FIG. 1 schematically shows a boat 1 having a motor drive system 2. Drive system 2 includes a first drive unit 3 and a second drive unit 4. Drive unit 3 includes a motor 5 and a drive designed as a jet 6. A propulsion reversal valve 7 is assigned to jet 6. Propulsion reversal valve 7 is operable via a controller 8.

Second drive unit 4 includes a second motor 9 and a second drive designed as a jet 10. A propulsion reversal valve 11, which is operable via a controller 12, is also assigned to jet 10.

An operating element 13, including a switch 30 for activating the automatic turning maneuver by the method according to the present invention, is assigned to drive system 2. Operating element 13 may have an additional switch 31, which should allow a direction in which the turn is to be made to be specified.

Operating element 13 is connected to a first control unit 15 and a second control unit 16 via signal lines 14. First control unit 15 is connected to motor 5 via a signal line 17, and second control unit 16 is connected to second motor 9 via a signal line 18. First control unit 15 allows control or regulation of the operation of motor 5 via signal line 17. Similarly, second control unit 16 allows control or regulation of second motor 9 via signal line 18. According to the present invention, both motor control units 15, 16 are interconnected via a signal line 19. Signal line 19 is designed as a bus system, for example. Controllers 8 and 12 may also be connected to bus system 19, but alternatively may also communicate directly with motor control units 15 and 16. Bus system 19 allows communication between both control units 15 and 16. Furthermore, bus system 19 allows triggering of controllers 8, 12 by control units 15, 16 for activating the propulsion reversal mode.

A steering wheel labeled with reference numeral 32 allows a direction to be specified by the driver of the boat.

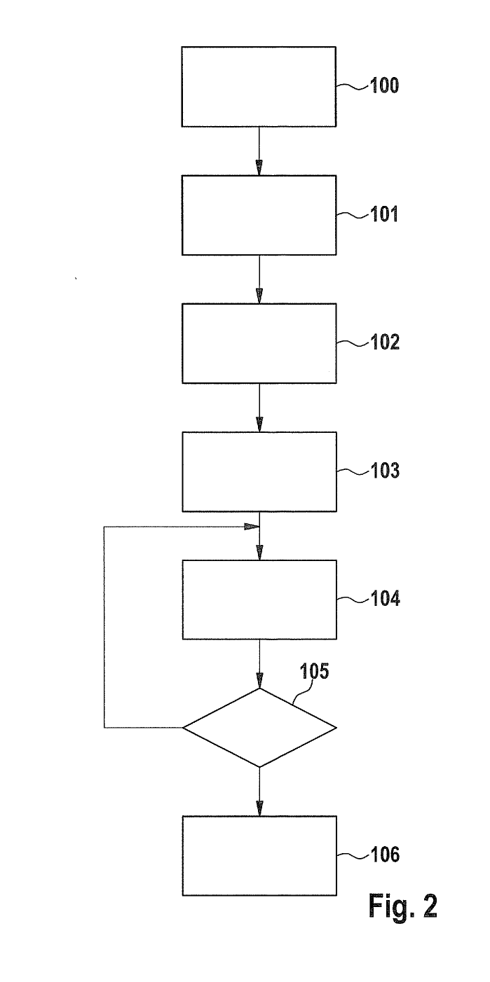

The exemplary embodiment illustrated in FIG. 1 is suitable for implementing the method according to the present invention. The mode of action of drive system 2 shown in FIG. 1 is described on the basis of the flow chart schematically shown in FIG. 2.

In a step 100, the driver of boat 1 requires the execution of a turning maneuver. For this purpose, the driver of the boat operates switch 30, for example, which is part of operating elements 13. The information about switch operation is relayed to at least one control unit 15, 16. This information is preferably relayed to both motor control units 15, 16.

In a step 101, a direction of turning is specified by the driver of the boat. This may be accomplished via additional switch 31. The direction of turning is preferably specified by moving steering wheel 32 in the desired direction of turning. For this purpose, steering wheel 32 and switch 31 are monitored by at least one control unit 15, 16 to ascertain whether a direction of turning has been specified.

In a step 102, the choice of drive unit 3, 4, which is to be operated to implement the turn in propulsion reversal mode, is made as a function of the specified direction of turning. If the driver of the boat has specified a clockwise direction of turning, then according to the present invention, activation of the propulsion reversal function of second drive unit 4 is automatically effected by second control unit 16. For this purpose, a corresponding activation signal is transmitted by second control unit 16 via bus system 19 to controller 12, which then causes propulsion reversal valve 11 to be activated. However, if a counterclockwise direction of turning has been specified, activation of propulsion reversal valve 7 of first drive unit 3 is effected by first control unit 15 by transmitting a suitable signal via bus system 19 to first controller 8.

In a step 103, first control unit 15 and second control unit 16 are synchronized by transmission of suitable signals over bus system 19, in such a way that in a step 104, a torque control is implemented for executing the turning maneuver by corresponding triggering of first motor 5 by first motor control unit 15 and triggering of second motor 9 by second control unit 16. For this purpose, a suitable torque specification is derived from a characteristics map stored in control units 15, 16, for example. This engine characteristics map allows compensation of the different efficiencies resulting from operation of a drive unit in propulsion mode on the one hand and in propulsion reversal mode on the other hand. Since one drive unit 3, 4 is operated in propulsion mode, while the other drive unit 3, 4 is operated in propulsion reversal mode to execute a turn, triggering of both drive units 5, 6 at the same motor torque or the same rotational speed would not allow turning on the spot because the efficiency of drive unit 3, 4 operated in propulsion mode is greater than the efficiency of drive unit 3, 4 operated in propulsion reversal mode. Turning exactly on the same spot cannot be ensured even when using the method according to the present invention. However, it is ensured that a turn on the spot and thus turning in a very tight space are automatically executable.

During the execution of the turn on the spot, there is a check in step 105 as to whether the turn on the spot is to be concluded. For this purpose, for example, switch 30 mounted on operating element 13 may again be queried in a suitable manner. If the switch is reset by the driver of the boat, then the turning maneuver is terminated in a step 106. For this purpose, drive unit 3, 4 operated in propulsion reversal mode for executing the turn is again switched to propulsion mode by deactivating propulsion reversal valve 7, 11 which is activated for this by control unit 15, 16 in a suitable manner.

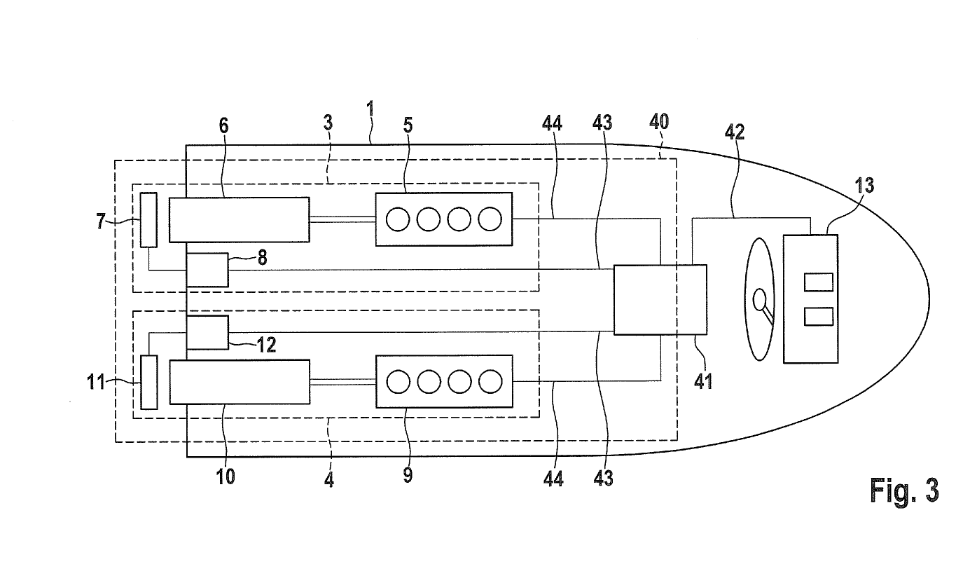

FIG. 3 shows another exemplary embodiment of a control system 40 according to the present invention. The exemplary embodiment shown in FIG. 3 differs from the exemplary embodiment shown in FIG. 1 in that drive system 40, which is shown in FIG. 3, has only one central control unit 41. Central control unit 41 controls the operation of both drive units 3, 4 and in particular both motors 5, 6. For this purpose, control unit 41 is connected to operating element 13 via a signal line 42, connected to controllers 8, 12 via additional signal lines 43 and connected to drive units 3, 4 via signal lines 44. In the exemplary embodiment shown in FIG. 3, no synchronization is required, as is the case with the exemplary embodiment illustrated in FIG. 1.

The exemplary embodiments shown in FIGS. 1 and 3 have been described on the basis of a jet drive. However, drive units 4 and 5 could also be implemented as so-called Z-drives. Implementation via outboard motors is also possible if a device for automatic activation of a propulsion reversal is present.

Drive units 3, 4 are preferably controllable via a so-called EGAS system. It is also conceivable that the automatic torque specification is made with the aid of a special actuator mechanism designed like the actuator which is present in known vehicle speed regulating systems.

The method according to the present invention and the device according to the present invention may be used in a plurality of boats, e.g., recreational boats or ferry boats. The only prerequisite is that the boat has at least two drive units, so that at least one drive unit is automatically operated in propulsion reversal mode for executing the turn and a torque specification is made automatically in such a way that different efficiencies are compensated. Use of the method according to the present invention and the device according to the present invention are consequently also conceivable on a sailboat if the sailboat has two motor drive units.

What is claimed is:

1. A method for controlling a motor drive system in a boat, the drive system including at least two controllable drive units, at least one of the drive units having a propulsion reversal function for executing a reverse propulsion, the method comprising:
automatically executing a triggering of the at least two drive units as a function of a command to turn, in such a way that turning at a minimum turning radius is made possible;
operating at least one drive unit at least temporarily in propulsion reversal mode when executing the turn, while operating another drive unit in propulsion mode; and
taking into account an instantaneous efficiency of the drive units operated during the turn in triggering of the drive units.

2. The method according to claim 1, wherein turning at a minimum turning radius includes turning on the spot.

3. The method according to claim 1, further comprising compensating different instantaneous efficiencies of the drive units by different torque requirements or rotational speed requirements.

4. The method according to claim 1, wherein the drive units have an electronic power control.

5. The method according to claim 1, wherein a rotational speed is specified via a throttle.

6. The method according to claim 1, wherein the drive system includes at least one jet drive, and at least one drive unit includes at least one jet.

7. The method according to claim 1, further comprising activating the drive units for executing the turn as a function of a specified direction of turning, a choice of the drive unit, which is operated in propulsion reversal mode, being made as a function of the specified direction of turning.

8. The method according to claim 7, further comprising evaluating an instantaneous position of a steering wheel for ascertaining the specified direction of turning.

9. The method according to claim 1, further comprising controlling the drive system with the aid of a central control unit, the central control unit controlling or regulating an operation of the at least two drive units.

10. The method according to claim 1, further comprising:
assigning a first control unit to a first drive unit for regulating or controlling an operation of the first drive unit;
assigning a second control unit to a second drive unit for regulating or controlling an operation of the second drive unit;
transmitting control signals from the first control unit to the second control unit via at least one signal line; and
operating the second drive unit as a function of the transmitted signals at least during an execution of the turn.

11. A device for controlling motor drive units in a boat, the boat including a drive system, the drive system including at least two controllable drive units, at least one of the drive units having a propulsion reversal function for executing a reverse propulsion, the device comprising:
at least one control unit for performing the following:
controlling or regulating the drive units,
automatically executing a triggering of the at least two drive units as a function of a command to turn, in such a way that turning at a minimum turning radius is made possible,
operating at least one drive unit at least temporarily in propulsion reversal mode when executing the turn, while operating another drive unit in propulsion mode, and
taking into account an instantaneous efficiency of the drive units operated during the turn in triggering of the drive units.

12. A computer-readable medium containing a computer program which when executed on at least one control unit performs a method for controlling a motor drive system in a boat, the drive system including at least two controllable drive units, at least one of the drive units having a propulsion reversal function for executing a reverse propulsion, the method comprising:
automatically executing a triggering of the at least two drive units as a function of a command to turn, in such a way that turning at a minimum turning radius is made possible;
operating at least one drive unit at least temporarily in propulsion reversal mode when executing the turn, while operating another drive unit in propulsion mode; and
taking into account an instantaneous efficiency of the drive units operated during the turn in triggering of the drive units.
